(19) United States
(12) Patent Application Publication
(10) Pub. No.: US 2025/0267572 A1
(43) Pub. Date: Aug. 21, 2025

(54) POWER MANAGEMENT OF ACCESS POINTS IN A NETWORK

(71) Applicant: Hewlett Packard Enterprise Development LP, Spring, TX (US)

(72) Inventors: Laura Silvia Neacsu, Jersey City, NJ (US); Jason Wadleigh, Scotch Plains, NJ (US); Christopher Hose, Westwood, NJ (US)

(21) Appl. No.: 18/442,260

(22) Filed: Feb. 15, 2024

(51) Int. Cl. H04W 52/02

(52) U.S. Cl. CPC H04W 52/0206

(57) ABSTRACT

An example method and a network management system for reducing power consumption by access points (APs) deployed in a network are presented. The network management system identifies a candidate AP for power saving from the plurality of APs based on telemetry data and using a machine learning model. The telemetry data includes information about client associations and network activity of the plurality of APs. Further, the network management system infers a power-saving transition for the candidate AP based on the telemetry data using the machine learning model. Then, as per the power-saving transition, the network management system operates the candidate AP in a power-saving mode.

### BACKGROUND

For sustainable technological advancements, the integration of green solutions has become a useful imperative. The escalating demand for wireless communication has resulted in an exponential increase in the number of wireless networking devices such as access points (APs) worldwide, leading to increased energy consumption and environmental impact. High energy consumption of such wireless networking devices translates into elevated operational costs for businesses and institutions. Further, powering and cooling network equipment in the network infrastructure represents a substantial portion of operational expenses.

### BRIEF DESCRIPTION OF THE DRAWINGS

One or more examples in the present disclosure are described in detail with reference to the following Figures. The Figures are provided for purposes of illustration only and merely depict examples.

FIG. 1 depicts a block diagram of a networked system in which various of the examples presented herein may be implemented.

FIG. 2 depicts a block diagram of an example access point (AP) including a processing resource and a machine-readable storage medium.

FIG. 3 depicts a flowchart of an example method for controlling power consumption by APs deployed in a networked system.

FIG. 4 depicts a flowchart of another example method for controlling power consumption by APs deployed in a networked system.

FIG. 5 depicts a flowchart of yet another example method for controlling power consumption by APs deployed in a networked system.

FIG. 6 depicts a block diagram of an example computing system.

The Figures are not exhaustive and do not limit the present disclosure to the precise form disclosed.

### DETAILED DESCRIPTION

Today, wireless devices are ubiquitous. From printers and smart televisions to Internet of Things (IoT) devices many devices vie for connection to wireless networks. Wireless networking devices such as wireless network controllers, routers, and access points provide wireless connectivity to such wireless devices. In particular, the electronic devices, such as wireless networking devices consume substantial energy, contributing to higher carbon footprints. As global concerns about climate change and environmental sustainability grow, there is a compelling need to reduce the energy consumption of networking devices. To achieve this, certain existing solutions entail moving compute loads to data centers with a lower carbon footprint.

Generally, the increased energy consumption by these wireless networking devices translates into elevated operational costs for businesses and institutions. Further, powering and cooling network equipment represent a significant portion of operational expenses, making energy-efficient solutions economically appealing. Additionally, governments and regulatory bodies are increasingly enforcing energy efficiency standards and environmental regulations.

Some known power management techniques entail using time-based scheduling of the wireless networking devices. In particular, these known power management techniques include turning off or moving the wireless networking devices into a deep-sleep mode during fixed intervals of low utilization such as during nights and weekends, etc. to reduce power consumption. As it is understood, such a technique of saving power is static and may not provide great power-saving benefits. On the contrary, such a static technique may cause connectivity interruptions to the client devices that need wireless connectivity during such periods when the wireless networking devices remain in the deep-sleep mode/powered off. Also, the wireless networking devices once moved to the deep sleep state or powered off, take some fixed time to come live again. This further leads to delays in providing wireless connectivity to the client devices.

To address the aforementioned challenges, in examples consistent with the teachings of this disclosure, a network management system and a method for intelligently managing the power consumption of wireless networking devices (e.g., APs) are presented. In particular, the network management system implements artificial intelligence to learn instances when an AP should be transitioned to a power-saving mode. In particular, the network management system receives telemetry data comprising information about client associations and network activity of the plurality of APs deployed in a network. Then, based on the telemetry data and using a machine learning (ML) model, the network management system may identify a candidate AP for power saving from the plurality of APs. The network management system may then infer the next power-saving transition for the candidate AP based on the telemetry data using the ML model. Accordingly, the network management system operates the candidate AP in a power-saving mode during the power-saving transition. In particular, in the power-saving mode various power-consuming components within the AP, such as the CPU, interfaces, and radios, are either deactivated or throttled to reduce energy consumption.

Further, in some examples, the network management system is also configured to control the power consumption of the AP based on roaming characteristics of client devices thereby dynamically reducing the power consumption by the AP. For example, the network management system may train the machine learning model to learn the roaming characteristics of a client device based on the client associations reported in the telemetry data over a predefined duration. The roaming characteristics define a temporal sequence of APs that the client device has associated with in a predefined interval. Once the ML model is trained, the network management system may infer a power-on transition for the candidate AP based on the learned roaming characteristics of a client device. Accordingly, the network management system may resume the operations of the candidate AP as per the power-on transition in advance of the client device associating with the candidate AP.

As will be appreciated, by combining AI-driven power management of the wireless networking devices organizations can significantly reduce the environmental impact of their wireless networks. This approach not only lowers energy costs but also contributes to a greener, more sustainable wireless network infrastructure. Further, due to the reduced energy consumption, the utility energy charges may be significantly reduced, making wireless networking devices a cost-effective choice for businesses. As will be appreciated, lower operational costs enhance the financial viability and competitiveness of organizations. Organizations that embrace green networking not only reduce operational costs but also gain a competitive advantage. Further, being associated with sustainable practices and responsible energy use fosters trust and loyalty among customers, partners, and stakeholders. The following detailed description refers to the accompanying drawings. It is to be expressly understood that the drawings are for the purpose of illustration and description only. While several examples are described in this document, modifications, adaptations, and other implementations are possible. Accordingly, the following detailed description does not limit disclosed examples. Instead, the proper scope of the disclosed examples may be defined by the appended claims.

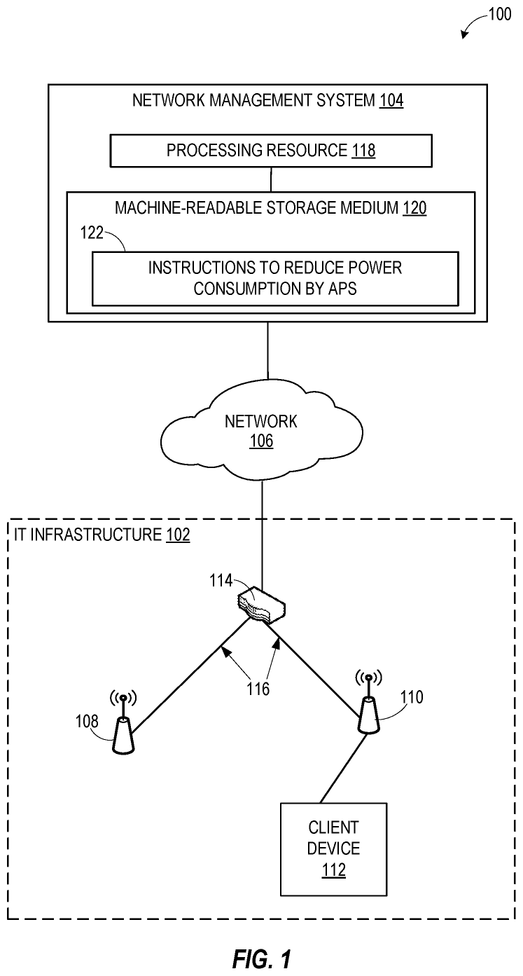

Before describing examples of the disclosed systems and methods in detail, it is useful to describe an example network installation with which these systems and methods might be implemented in various applications. FIG. 1 illustrates a system 100 in which various of the examples presented herein may be implemented. The system 100 may be implemented for any setup, for example, in a home setup or an organization, such as a business, educational institution, governmental entity, healthcare facility, or other organization. The system 100 may include an IT infrastructure 102, or both the IT infrastructure 102 and a network management system 104. In FIG. 1, although the network management system 104 is shown external to the IT infrastructure 102, in some examples, the network management system 104 may be hosted in the IT infrastructure 102.

The IT infrastructure 102 may be of a small-scale network of devices or a large-scale network of devices. The small-scale network of devices may be a home network hosting a smaller number of network management systems, for example. The large-scale network of devices may be an organization, university, public utility space (e.g., mall, airport, railway station, bus station, stadium, etc.), or office network hosting a large number of network management systems, for example. The IT infrastructure 102 may span across more than one site, for example, a room, a floor of a building, a building, or any other geographically separated spaces. The IT infrastructure 102 may be a private network, such as a network that may include security and access controls to restrict access to authorized users of the private network.

The IT infrastructure 102 may include several devices that communicate with each other and/or with any external device or system outside the IT infrastructure 102. For illustration purposes, the IT infrastructure 102 of FIG. 1 is shown to include two wireless networking devices, such as, APs 108 and 110 (hereinafter collectively referred to as APs 108, 110) and a client device 112. Further, in some examples, the IT infrastructure 102 may optionally include a controller 114 that is in communication with an external network 106. It is to be noted that the examples presented herein are not limited by the specifics (e.g., types and counts) of the devices depicted in FIG. 1. In some examples, the APs 108, 110, the client device 112, and the controller 114 may be configured to communicate with other devices using wireless communication techniques specified in one or more IEEE 802.11 standard specifications. The APs 108, 110 may act as a point of access to a local network established in IT infrastructure 102 and/or the external network 106 for the client device 112. Each of APs 108, 110 may be a combination of hardware, software, and/or firmware that is configured to provide wireless network connectivity to client device 112. The APs 108, 110 may communicate with the client devices (e.g., the client device 112) in accordance with one or more IEEE 802.11 standard specifications.

The examples of the client device 112 may include desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smartphones, virtual terminals, video game consoles, virtual assistants, Internet-of-Things (IoT) devices, and the like.

Each of the APs 106-108 may communicate with the controller 114 over respective connections 116, which may include wired and/or wireless interfaces. The controller 114 may provide communication with the network 106 for the IT infrastructure 102, though it may not be the only point of communication with the network 106 for the IT infrastructure 102. In some examples, the controller 114 may communicate with the network 106 through a router (not shown). In other implementations, the controller 114 may provide router functionality to the devices in the IT infrastructure 102. In some examples, the controller 114 may be a wireless local area network (WLAN) controller. The controller 114 may be operable to configure and manage network management systems, such as at the IT infrastructure 102, and may also manage network management systems at other remote sites, if any, within the IT infrastructure 102. The controller 114 may be operable to configure and/or manage switches, routers, access points, and/or client devices connected to a network. The controller 114 may itself be, or provide the functionality of, an AP.

The network 106 may be a public or private network, such as the Internet, or another communication network to allow connectivity between the IT infrastructure 102 and the network management system 104. The network 106 may include third-party telecommunication lines, such as phone lines, broadcast coaxial cables, fiber optic cables, satellite communications, cellular communications, and the like. In some examples, the network 106 may include any number of intermediate network management systems, such as switches, routers, gateways, servers, and/or controllers, which are not directly part of the IT infrastructure 102 but that facilitate communication between the various parts of the IT infrastructure 102, and between the IT infrastructure 102 and any other network-connected entities.

Further, in some examples, the system 100 may include the network management system 104 which may be hosted on a network outside the IT infrastructure 102. In some examples, the network management system 104 may be deployed on a cloud platform hosted on a public, private, or hybrid cloud outside the IT infrastructure 102. In some examples, the network management system 104 may be implemented as one or more computing systems, for example, computers, controllers, servers, or storage systems. The network management system 104 may be an electronic device having a hardware processing resource 118, such as one or more central processing units (CPUs), semiconductor-based microprocessors, and/or other hardware devices suitable for retrieval and execution of instructions 122 stored in a machine-readable storage medium 120 (described later). In certain other examples, the network management system 104 may be implemented as a software resource, such as a software application, a virtual machine (VM), a container, a containerized application, or a pod. In some examples, the network management system 104 may be implemented as a service running on a “cloud computing” environment or as a “software as a service” (SaaS). The network management system 104 may be offered as a stand-alone product or a packaged solution that can be utilized on a one-time full product/solution purchase or pay-per-use basis.

In certain other examples, not shown in FIG. 1, the network management system 104 may be deployed within the IT infrastructure 102. In such an implementation, the network management system 104 may be connected to controller 114 or any of the APs 108, 110. In some other examples, the network management system 104 may be implemented as an AP. In an alternative implementation, the controller 114 may be configured to operate as the network management system 104.

The machine-readable storage medium 120 may be non-transitory and is alternatively referred to as a non-transitory machine-readable storage medium that does not encompass transitory propagating signals. The machine-readable storage medium 120 may be any electronic, magnetic, optical, or another type of storage device that may store data and/or executable instructions. Examples of the machine-readable storage medium 120 may include Random Access Memory (RAM), non-volatile RAM (NVRAM), an Electrically Erasable Programmable Read-Only Memory (EEPROM), a storage drive (e.g., a solid-state drive (SSD) or a hard disk drive (HDD)), a flash memory, and the like. The machine-readable storage medium 120 may be encoded with instructions 122 to control the power consumption by the APs 108, 110. Although not shown, in some examples, the machine-readable storage medium 120 may be encoded with certain additional executable instructions to perform any other operations performed by the network management system 104, without limiting the scope of the present disclosure.

The processing resource 118 may be a physical device, for example, a central processing unit (CPU), a microprocessor, a graphics processing unit (GPU), a field-programmable gate array (FPGA), application-specific integrated circuit (ASIC), other hardware devices capable of retrieving and executing instructions stored in the machine-readable storage medium 120, or combinations thereof. The processing resource 118 may fetch, decode, and execute the instructions 122 stored in the machine-readable storage medium 120 to control the power consumption by the APs 108, 110, in particular, by controlling the operating power modes of the APs 108, 110 based on telemetry data reported by the APs 108, 110. As an alternative or in addition to executing the instructions 122, the processing resource 118 may include at least one integrated circuit (IC), control logic, electronic circuits, or combinations thereof that include a number of electronic components for performing the functionalities intended to be performed by the network management system 104. In some examples, when the network management system 104 is implemented as a virtual resource (e.g., a VM, a container, or a software application), the processing resource 118 and the machine-readable storage medium 120 may respectively represent a processing resource and a machine-readable storage medium of a host system hosting the network management system 104 as the virtual resource.

In examples consistent with the teachings of this disclosure, the network management system 104 may implement, by way of the processing resource 118 executing the instructions 122, a method of controlling the power consumption by the APs 108, 110 by using artificial intelligence to learn instances when an AP (e.g., one or more of the APs 108, 110) should be transitioned to a power-saving mode. In particular, the network management system 104 receives telemetry data comprising information about client associations and network activity of the plurality of APs 108, 110 deployed in the IT infrastructure 102. Then, based on the telemetry data and using a machine learning (ML) model, the network management system 104 may identify a candidate AP for power saving from the plurality of APs. The candidate AP may be an AP or APs from the APs 108, 110 that can be operated in a power-saving mode (e.g., sleep mode, deep-sleep mode, or power-off). The network management system 104 may then infer the next power-saving transition for the candidate AP based on the telemetry data using the ML model. Accordingly, the network management system 104 operates the candidate AP in a power-saving mode during the power-saving transition. In particular, in the power-saving mode various power-consuming components within the AP, such as the CPU, interfaces, and radios, are either deactivated or throttled to reduce energy consumption.

Further, in some examples, the network management system 104 is also configured to control the power consumption of the APs based on roaming characteristics of client devices (e.g., the client device 112) thereby dynamically reducing the power consumption by the APs. For example, the network management system 104 may train the ML model to learn the roaming characteristics of a client device 112 based on the client associations reported in the telemetry data over a predefined duration. The roaming characteristics define a temporal sequence of APs that the client device 112 has associated with in a predefined interval. Once the ML model is trained, the network management system 104 may infer a power-on transition for the candidate AP based on the learned roaming characteristics of the client device 112. Accordingly, the network management system may resume the operations of the candidate AP as per the power-on transition in advance of the client device 112 associating with the candidate AP.

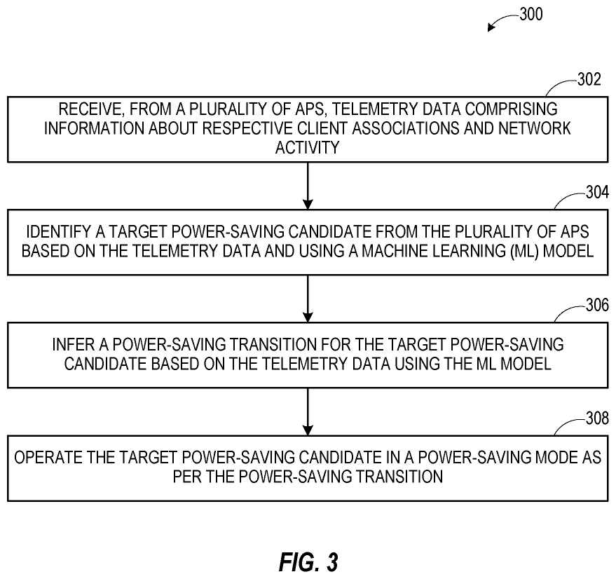

Additional details of controlling the operations of the APs thereby reducing the power consumption are described in conjunction with the methods described in FIGS. 3-5, provided in detail subsequently in the present disclosure.

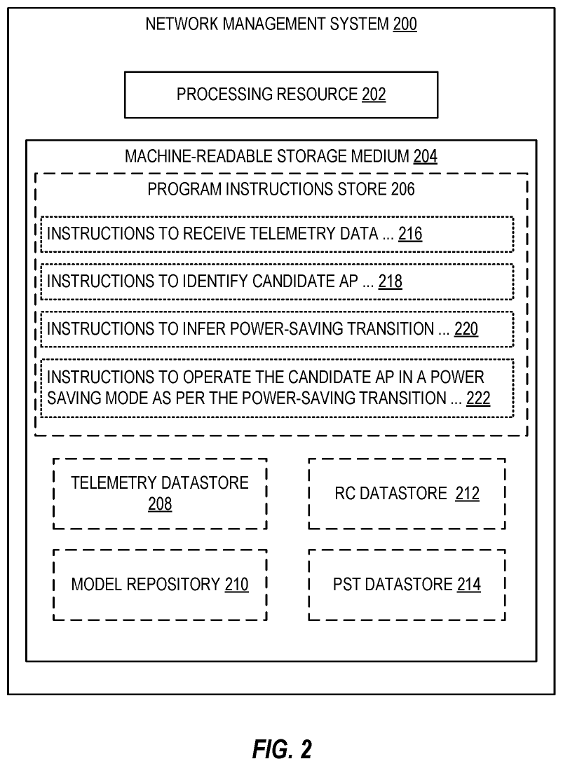

Referring now to FIG. 2, a block diagram of an example network management system is presented. The network management system 200 of FIG. 2 may be an example representative of the network management system 104 of FIG. 1. The network management system 200 may be configured to manage the functioning of wireless networking devices, for example, APs (e.g., the APs 108, 110 shown in FIG. 1) to reduce the power consumed by such APs. In some examples, the network management system 200 may include a processing resource 202 and/or a machine-readable storage medium 204 for the network management system 200 to execute several operations as will be described in the greater details below. The processing resource 202 and the machine-readable storage medium 204 may be example representatives of the processing resource 118 and the machine-readable storage medium 120, respectively, of FIG. 1, certain details of which are not repeated herein for the sake of brevity.

The machine-readable storage medium 204 may include program instructions store 206 including instructions (depicted using a dashed box in FIG. 2) for controlling power consumption by the APs deployed in a wireless network (e.g., the IT infrastructure 102). In addition to the program instructions store 206, in some examples, the machine-readable storage medium 204 may also include certain additional data stores, for example, telemetry datastore 208, the model repository 210, roaming characteristic datastore 212 (marked as “RC datastore” in FIG. 2), and a power-saving transition datastore 214 (marked as “PST datastore” in FIG. 2). In particular, the telemetry datastore 208 includes information about client associations and network activity of the plurality of APs. In particular, the APs deployed in an IT infrastructure, such as, the IT infrastructure 102 may be configured to report, periodically or on demand by the network management system 200, the telemetry data to the network management system 200. Such telemetry data may be stored by the processing resource 202 for later processing, such as, ML model training and/or generating various inferences using the ML models. The model repository 210 includes one or more ML models that the processing resource 202 may use to control the operations of the APs to reduce power consumption. Further, the roaming characteristic datastore 212 may include details about the roaming behavior/pattern of the client devices that the processing resource 202 may have learned or inferred based on the telemetry data using the ML models. For example, for a given client device, the roaming pattern may include a temporal sequence of APs that the given client device has associated with in a predefined interval. Furthermore, the power-saving transition datastore 214 may include information on the power-saving transitions that the processing resource 202 may have learned or inferred based on the telemetry data using the ML models.

Further, in some examples, the program instructions store 206 includes instructions 216, 218, 220, and 222. The instructions 216 when executed by the processing resource 202 may cause the processing resource 202 to receive, from a plurality of APs, telemetry data comprising information about client associations and network activity of the plurality of APs. Further, the instructions 218 when executed by the processing resource 202 may cause the processing resource 202 to identify a candidate AP for power saving from the plurality of APs based on the telemetry data and using a machine learning model. Furthermore, the instructions 220 when executed by the processing resource 202 may cause the processing resource 202 to infer a power-saving transition for the candidate AP based on the telemetry data using the machine learning model. Moreover, the instructions 222 when executed by the processing resource 202 may cause the processing resource 202 to operate the candidate AP in a power-saving mode during the power-saving transition. Further, in some examples, the machine-readable storage medium 204 may be encoded with certain additional executable instructions to perform any other operations performed by the network management system 200, without limiting the scope of the present disclosure. The processing resource 202 may access the telemetry datastore 208, the model repository 210, the roaming characteristic datastore 212, and the power-saving transition datastore 214 to access and/or store the relevant data while executing one or more of the instructions. Additional details about the operations performed by the processing resource 202 by executing the instructions 208-214 are described in conjunction with the method described in FIGS. 3-5.

In the description hereinafter, various operations performed by a suitable system are described with the help of flowcharts depicted in FIGS. 3-5. In particular, FIGS. 3-5 depict flowcharts of example methods for controlling wireless networking devices, for example, APs to reduce respective power consumption. The steps that are shown in FIGS. 3-5 may be performed locally at the suitable device, such as a network management system (e.g., the network management system 104 shown in FIG. 1 or the network management system 200 shown in FIG. 2) or a WLAN controller (e.g., the controller 114 shown in FIG. 1). For illustration purposes, the steps shown in the FIGS. 3-5 are described as being performed by a network management system, for example, the network management system 104, 200. In some examples, the suitable device may include a processing resource suitable for retrieval and execution of instructions stored in a machine-readable storage medium. Further, the flowcharts that are shown in FIGS. 3-5 include several steps in a particular order. However, the order of steps shown in the respective flowcharts should not be construed as the only order for the steps. The steps may be performed at any time, in any order. Additionally, the steps may be repeated or omitted as needed.

Referring now to FIG. 3, a flowchart of an example method for controlling power consumption by wireless networking devices such as APs is presented. As noted above, for illustration purposes, the method 300 of FIG. 3 is described as being performed by a network management system, for example, the network management system 104 of FIG. 1 or the network management system 200 of FIG. 2.

At step 302, the network management system may receive telemetry data from APs (e.g., the APs 108, 110) deployed in the IT infrastructure (e.g., the IT infrastructure 102). In some examples, the APs are programmed to send, periodically or at random intervals, the telemetry data to the network management system. In certain examples, the network management system may request the APs to send the telemetry data, and in response to such requests, the APs may send the telemetry data to the network management system. In certain other examples, the APs are programmed to send the telemetry data to the network management system based on the occurrence of certain events, such as, new client device associations, a number of client device associations reducing below a threshold value, network traffic reducing below a certain value, on detecting performance issues (e.g., device heating), etc. The telemetry data reported by a given APs may include information about client associations (e.g., the number of client devices currently associated with the given AP), network activity (e.g. The number of bits sent and/or received, the number of retransmits, the number and/or types of errors, channel, data rates, application data flows, etc.), received signal strengths (e.g., Received Signal Strength Indicator (RSSI) values), with respect to other APs in the IT infrastructure, power consumed by the given AP, roaming characteristics, etc. The roaming characteristics may include a temporal sequence of APs that the client device has associated with in a predefined interval. Upon receiving the telemetry data, the network management system may store the telemetry data in a telemetry datastore, for example, the telemetry datastore 208.

Further, at step 304, the network management system may identify a candidate AP for power saving (hereinafter referred to as a “target power-saving candidate”) from the plurality of APs based on the telemetry data and using an ML model. Before using the ML model for identifying the target power-saving candidate, the ML model may be trained using a training data set during a learning phase to learn several criteria for determining when an AP should be categorized as a target power-saving candidate. In one example, the ML model may learn one or more reduced utilization patterns for each of the plurality of APs deployed in the IT infrastructure. For a given AP, a reduced utilization pattern may indicate when and in what conditions the given AP has less utilization which is indicative of reduced network activity or a reduced number of client devices associated with the given AP. Then, based on the real-time telemetry data (for example, the network activity, and client associations received at step 302) as an input and the ML model, the network management system may infer if a given AP may encounter any reduced utilization pattern during its operation. If it is determined that the given AP is likely to encounter a reduced utilization pattern, the network management system may consider the given AP as the target power-saving candidate.

Further, at step 306, the network management system may infer the power-saving transition for the target power-saving candidate based on the telemetry data using the ML model. As will be appreciated, for reduced power consumption, it is beneficial to operate certain APs in sleep mode. In particular, the power-saving transition may refer to a schedule during which the target power-saving candidate may be operated in a power-saving mode. The target power-saving candidate when operated in the power-saving mode may consume reduced power compared to its normal operating mode. As previously noted, the ML model has learned various reduced utilization patterns for the APs in the network. Accordingly, at step 306, based on the real-time telemetry data received at step 302, the network management system may determine when the target power-saving candidate is likely to experience a reduced utilization. Such a time when the target power-saving candidate is likely to experience a reduced utilization may be determined as the power-saving transition for the target power-saving candidate.

In some examples, the reduced utilization pattern for the target power-saving candidate might have been caused by certain events such as an increased number of client devices dissociating from the target power-saving candidate, time of the day (e.g., nighttime low network usage), time restrictions (e.g., after office-hour), etc. Accordingly, in such cases, the power-saving transition may be an event that may potentially cause the reduced utilization of an AP. The time or an event at which the power-saving transition may begin is hereinafter referred to as a power-saving transition trigger.

Once the power-saving transition for the target power-saving candidate is identified, the network management system may, at step 308, operate the target power-saving candidate in a power-saving mode at the power-saving transition trigger. As will be appreciated, the target power-saving candidate may consume reduced or no power during the period when the target power-saving candidate is operating in the power-saving mode. In some examples, operating the target power-saving candidate in the power-saving mode includes operating the target power-saving candidate in a sleep mode (also alternatively referred to as a “low-power mode”). In the sleep mode, certain functions and/or hardware units of the target power-saving candidate may be disabled. For example, in the sleep mode, one or more of the SSIDs may be disabled, and/or certain ancillary services such as a powered USB interface, the secondary ethernet interface, etc. may be disabled. Also, in some examples, one or more software processes may be stopped in the sleep mode to reduce memory and processor utilization.

Furthermore, in some examples, operating the target power-saving candidate in the power-saving mode includes operating the target power-saving candidate in a deep-sleep mode. The target power-saving candidate when operated in the deep-sleep mode may consume lesser power compared to its operation in the sleep mode. In particular, in the deep-sleep mode, an increased number of SSIDs, ancillary services, and software processes may be disabled compared to the sleep mode. In certain examples, the target power-saving candidate may be powered off when operated in the deep-sleep mode.

Alternatively, in some examples, operating the target power-saving candidate in the power-saving mode includes-first operating the target power-saving candidate in the sleep mode followed by operating the target power-saving candidate in the deep-sleep mode. The target power-saving candidate may be transitioned from the sleep mode to the deep-sleep mode responsive to determining that there is no data traffic for the target power-saving candidate for a predefined duration after the target power-saving candidate enters the sleep mode.

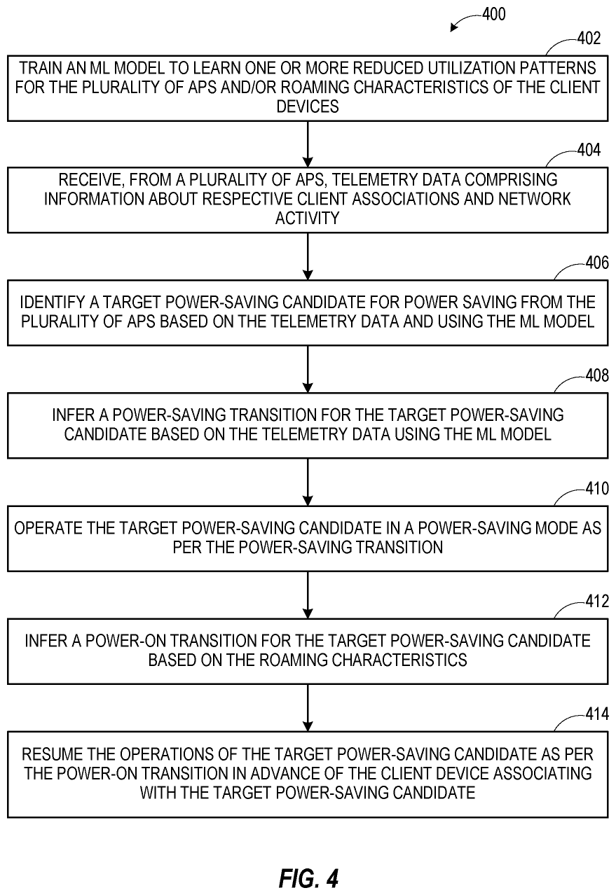

FIG. 4 depicts a flowchart of another example method for controlling power consumption by APs deployed in a networked system. The method 400 of FIG. 4 includes certain steps that are similar to those described in FIG. 3, certain details of which are not repeated herein for the sake of brevity.

Before the network management system uses an ML model to infer how to operate APs (e.g., the APs 108, 110) deployed in the IT infrastructure (e.g., the IT infrastructure 102) to reduce power consumption, the network management system is configured to train the ML model during a learning phase. In an example, the learning phase may be completed before the ML model is executed to generate inferences. In some examples, the learning phase may continue while the ML model is generating the inferences. Accordingly, at step 402, during the learning phase, the network management system may be configured to train an ML model to learn one or more reduced utilization patterns for the plurality of APs and/or roaming characteristics of the client devices, based on the network activity reported in the telemetry data. In particular, during the learning phase, the network management system receives a training dataset that may include sample telemetry data and inputs about the reduced utilization patterns. Based on the sample telemetry data and inputs about the reduced utilization patterns, the ML model may be trained, using one or more ML training techniques, to extract several features that may establish relationships between the sample telemetry data and the reduced utilization patterns. Also, in some examples, during the learning phase, the ML model may be trained to learn the roaming characteristics of the client devices. In particular, the ML model may learn, for each client device, a temporal sequence of APs that the client device has associated with while roaming in the IT infrastructure. After the ML model is trained with the sample telemetry data, the ML model may be deployed for run time or production use which may commence at step 404.

Further, at step 404, during the operation, the network management system may receive telemetry data from APs deployed in the IT infrastructure. The telemetry data reported by a given APs may include information about client associations, network activity, received signal strengths (e.g., Received Signal Strength Indicator (RSSI) values), with respect to other APs in the IT infrastructure, power consumed by the given AP, roaming characteristics, etc.

Further, at step 406, the network management system may identify a candidate AP for power saving (also referred to as a “target power-saving candidate”) from the plurality of APs based on the telemetry data and using an ML model, in a similar fashion as described in conjunction with FIG. 3. Furthermore, at step 408, the network management system may infer the power-saving transition for the target power-saving candidate based on the telemetry data using the ML model, in a similar fashion as described in conjunction with FIG. 3.

Once the power-saving transition for the target power-saving candidate is identified, the network management system may, at step 410, operate the target power-saving candidate in a power-saving mode at the power-saving transition trigger. As will be appreciated, the target power-saving candidate may consume reduced or no power during the period when the target power-saving candidate is operating in the power-saving mode. In some examples, operating the target power-saving candidate in the power-saving mode includes operating the target power-saving candidate in a sleep mode or deep-sleep mode. Alternatively, in some examples, operating the target power-saving candidate in the power-saving mode includes-first operating the target power-saving candidate in the sleep mode followed by operating the target power-saving candidate in the deep-sleep mode.

Furthermore, in some examples, at step 412, the network management system may infer a power-on transition for the target power-saving candidate based on the learned roaming characteristics of a client device and the real-time telemetry data that the network management system receives from the APs. The power-on transition may refer to a time or event at which the target power-saving candidate may be brought back to its normal operation. The power-on transition may be a time of the day when the target power-saving candidate generally resumes or engages in the network activity, or any event such as a client device likely to associate with the target power-saving candidate. In particular, in one example, using the ML model and temporal sequence of the APs that the client device is connecting with, the network management system may predict which is the next AP that the client device is going to associate with. If it is determined that the next AP that the client device is going to associate with is the target power-saving candidate that is operating the power-saving mode, the network management system, at step 414, may resume the operations of the target power-saving candidate as per the power-on transition in advance of the client device associating with the target power-saving candidate.

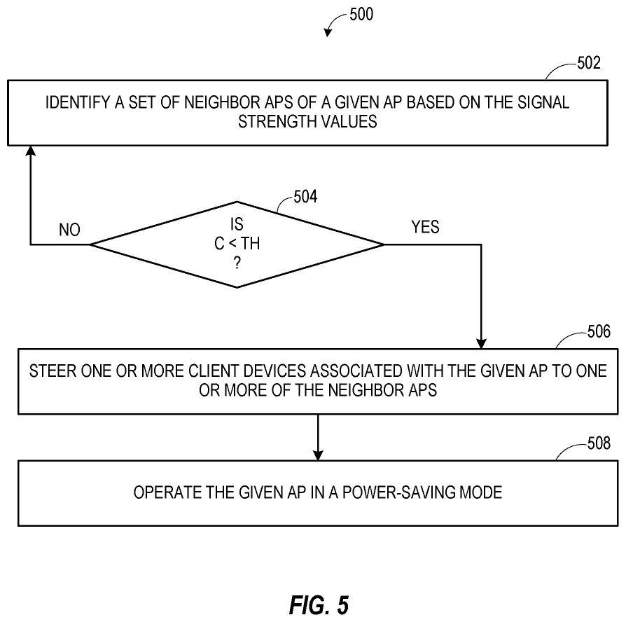

Turning now to FIG. 5, a flowchart of yet another example method for controlling power consumption by APs deployed in a networked system is presented. For illustration purposes, the method 500 of FIG. 5 is described as being performed by a network management system, for example, the network management system 104 of FIG. 1 or the network management system 200 of FIG. 2. Although shown separately in FIG. 5, the method 500 may be performed anytime during the execution of the method 300 of FIG. 3 and the method 400 of FIG. 4.

At step 502, the network management system may identify a set of neighbor APs of a given AP based on the signal strength values. As previously noted, the telemetry data reported by the APs in the IT infrastructure may include signal strength values (e.g., RSSI values) with respect to the rest of the plurality of APs in the IT infrastructure. In some examples, for a given AP, the network management system may identify, from the RSSI values reported by the given AP, one or more RSSI values that are within a predefined range. The network management system may consider APs whose RSSI values are found to be within the predefined range may be identified as the neighbor APs for the given AP.

Further, at step 504, the network management system may perform a check to determine if a count (‘C’) of the client devices associated with the given AP has reduced below a threshold number (‘TH’). At step 404, if it is determined that the count of the client devices associated with the given AP has not reduced below the threshold number, the network management system may move the execution to step 502 where it may continue to update the list of the neighbor APs for the given AP based on the signal strength values reported in the telemetry data. However, at step 504, if it is determined that the count of the client devices associated with the given AP has reduced below the threshold number, the network management system may, at step 506, steer one or more client devices associated with the given AP to one or more of the neighbor APs. The steering of the client device may include dissociating the client devices from the given AP and associating the client devices with one or more of the neighbor APs.

After the client devices are steered to another AP(s), the network management system, at step 508, may operate the given AP in the power-saving mode. In a similar fashion described in conjunction with FIG. 3, the network management system may operate the given AP in the sleep mode or the deep-sleep mode.

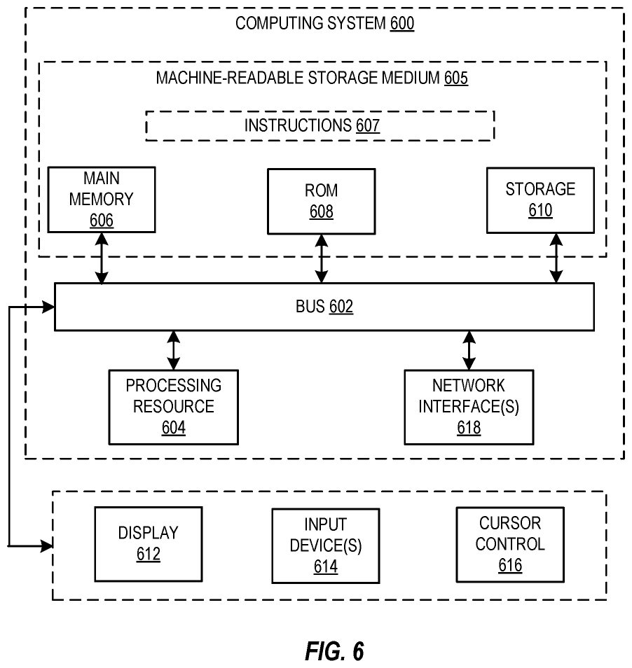

FIG. 6 depicts a block diagram of an example computing system 600 in which various of the examples described herein may be implemented. In some examples, the computing system 600 may be configured to operate as a network management system, such as the network management system 104 of FIG. 1, and can perform various operations described in one or more of the earlier drawings. In certain examples, the computing system 600 may be configured to operate as a WLAN controller, such as the controller 114 of FIG. 1, and can perform various operations described in one or more of the earlier drawings. Examples of the devices and/or systems that may be implemented as the computing system 600 may include, desktop computers, laptop computers, servers, web servers, authentication servers, Authentication, Authorization, and Accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, Personal Digital Assistants (PDAs), mobile phones, smartphones, smart terminals, dumb terminals, virtual terminals, video game consoles, virtual assistants, IoT devices, and the like.

The computing system 600 may include a bus 602 or other communication mechanisms for communicating information, a hardware processor, also referred to as processing resource 604, and a machine-readable storage medium 605 coupled to the bus 602 for processing information. In some examples, the processing resource 604 and the machine-readable storage medium 605 may be example representatives of the processing resource 118 and the machine-readable storage medium 120, respectively, depicted in FIG. 1. In some examples, the machine-readable storage medium 605 may include a main memory 606, such as a RAM, cache and/or other dynamic storage devices, coupled to the bus 602 for storing information and instructions to be executed by the processing resource 604. The main memory 606 may also be used for storing temporary variables or other intermediate information during the execution of instructions to be executed by the processing resource 604. Such instructions, when stored in storage media accessible to the processing resource 604, render the computing system 600 into a special-purpose machine that is customized to perform the operations specified in the instructions. The machine-readable storage medium 605 may further include a read-only memory (ROM) 608 or other static storage device coupled to the bus 602 for storing static information and instructions for the processing resource 604. Further, in the machine-readable storage medium 605, a storage device 610, such as a magnetic disk, optical disk, or USB thumb drive (Flash drive), etc., may be provided and coupled to the bus 602 for storing information and instructions.

In some examples, the computing system 600 may be coupled, via the bus 602, to a display 612, such as a liquid crystal display (LCD) (or touch-sensitive screen), for displaying information to a computer user. In some examples, an input device 614, including alphanumeric and other keys (physical or software generated and displayed on a touch-sensitive screen), may be coupled to the bus 602 for communicating information and command selections to the processing resource 604. Also, in some examples, another type of user input device such as a cursor control 616 may be connected to the bus 602. The cursor control 616 may be a mouse, a trackball, or cursor direction keys. The cursor control 616 may communicate direction information and command selections to the processing resource 604 for controlling cursor movement on the display 612. In some other examples, the same direction information and command selections as cursor control may be implemented via receiving touches on a touch screen without a cursor.

In some examples, the computing system 600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The computing system 600 also includes a network interface 618 coupled to bus 602. The network interface 618 provides a two-way data communication coupling to one or more network links that are connected to one or more local networks. For example, the network interface 618 may be an integrated services digital network (ISDN) card, cable modem, satellite modem, or a modem to provide a data communication connection to a corresponding type of telephone line. As another example, the network interface 618 may be a local area network (LAN) card or a wireless communication unit (e.g., Wi-Fi chip/module).

In some examples, the machine-readable storage medium 605 (e.g., one or more of the main memory 606, the ROM 608, or the storage device 610) stores instructions 607 which when executed by the processing resource 604 may cause the processing resource 604 to execute one or more of the methods/operations described hereinabove. The instructions 607 may be stored on any of the main memory 606, the ROM 608, or the storage device 610. In some examples, the instructions 607 may be distributed across one or more of the main memory 606, the ROM 608, or the storage device 610. In some examples, when the computing system 600 is configured to operate as a network management system 104, the instructions 607 (e.g., instructions similar to the instructions 208-214 shown in FIG. 2) may include instructions that when executed by the processing resource 604 may cause the processing resource 604 to perform one or more of the methods described in FIGS. 3-5.

Terms and phrases used in this document, and variations thereof, unless otherwise expressly stated, should be construed as open-ended as opposed to limiting. As examples of the foregoing, the term “including” should be read as meaning “including, without limitation” or the like. The term “example” is used to provide exemplary instances of the item in the discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent. Further, the term “and/or” as used herein refers to and encompasses any and all possible combinations of the associated listed items. It will also be understood that, although the terms first, second, third, etc., may be used herein to describe various elements, these elements should not be limited by these terms, as these terms are only used to distinguish one element from another unless stated otherwise or the context indicates otherwise.

What is claimed is:

1. A method comprising:
receiving, by a network management system from a plurality of access points (APs) deployed in a network, telemetry data comprising information about client associations and network activity of the plurality of APs;
identifying, by the network management system, a candidate AP for power saving from the plurality of APs based on the telemetry data and using a machine learning model;
inferring, by the network management system, a power-saving transition for the candidate AP based on the telemetry data using the machine learning model; and
operating, by the network management system, the candidate AP in a power-saving mode as per the power-saving transition.

2. The method of claim 1, further comprising training the machine learning model, by the network management system during a learning phase, to learn one or more reduced utilization patterns for the plurality of APs, based on the network activity reported in the telemetry data.

3. The method of claim 2, further comprising using the machine learning model to identify the candidate AP and infer the power-saving transition for the candidate AP based on the learned one or more reduced utilization patterns.

4. The method of claim 1, further comprising training the machine learning model, by the network management system, to learn roaming characteristics of a client device based on the client associations reported in the telemetry data, wherein the roaming characteristics define a temporal sequence of APs that the client device has associated within a predefined interval.

5. The method of claim 4, further comprising:
inferring, by the network management system, a power-on transition for the candidate AP based on the learned roaming characteristics of a client device; and
resuming, by the network management system, operations of the candidate AP as per the power-on transition in advance of the client device associating with the candidate AP.

6. The method of claim 1, wherein the telemetry data reported by a given AP of the plurality of APs, further comprises signal strength values with respect to the rest of the plurality of APs in the network.

7. The method of claim 6, further comprising determining, by the network management system, a set of neighbor APs of the given AP, based on the signal strength values.

8. The method of claim 7, further comprising steering, by the network management system, one or more client devices associated with the given AP to one of the set of neighbor APs responsive to determining that a count of the one or more client devices associated with the given AP has reduced below a threshold number.

9. The method of claim 8, further comprising operating, by the network management system, the given AP in the power-saving mode after the one or more client devices have been steered to the one of the set of neighbor APs.

10. The method of claim 1, wherein operating the candidate AP in the power-saving mode comprises:
operating the candidate AP in a sleep mode;
operating the candidate AP in a deep-sleep mode; or
first operating the candidate AP in the sleep mode followed by operating the candidate AP in the deep-sleep mode responsive to determining no-data traffic for the candidate AP for a predefined duration after the candidate AP entered the sleep mode.

11. A network management system comprising:
a machine-readable storage medium storing executable instructions; and
a processing resource coupled to the machine-readable storage medium and configured to execute one or more of the instructions to:
receive, from a plurality of access points (APs) deployed in a network, telemetry data comprising information about client associations and network activity of the plurality of APs;
identify a candidate AP for power saving from the plurality of APs based on the telemetry data and using a machine learning model;
infer a power-saving transition for the candidate AP based on the telemetry data using the machine learning model; and
operate the candidate AP in a power-saving mode as per the power-saving transition.

12. The network management system of claim 11, wherein the processing resource is configured to execute one or more of the instructions to:
train the machine learning model, during a learning phase, to learn one or more reduced utilization patterns for the plurality of APs, based on the network activity reported in the telemetry data; and
identify the candidate AP and infer the power-saving transition for the candidate AP based on the learned one or more reduced utilization patterns.

13. The network management system of claim 11, wherein the processing resource is configured to execute one or more of the instructions to train the machine learning model to learn roaming characteristics of a client device based on the client associations reported in the telemetry data, wherein the roaming characteristics define a temporal sequence of APs that the client device has associated with in a predefined interval.

14. The network management system of claim 11, wherein the processing resource is configured to execute one or more of the instructions to:
infer a power-on transition for the candidate AP based on the learned roaming characteristics of a client device; and
resume operations of the candidate AP as per the power-on transition in advance of the client device associating with the candidate AP.

15. The network management system of claim 11, wherein the processing resource is configured to execute one or more of the instructions to:
determine a set of neighbor APs of a given AP of the plurality of APs; and
steer one or more client devices associated with the given AP to one of the set of neighbor APs responsive to determining that a count of the one or more client devices associated with the given AP has reduced below a threshold number.

16. A system comprising:
an access point (AP) configured to provide wireless network connectivity to a client device; and
a network management system coupled to the AP, wherein the network management system is configured to:
receive, from a plurality of access points (APs) deployed in a network, telemetry data comprising information about client associations and network activity of the plurality of APs;
identify a candidate AP for power saving from the plurality of APs based on the telemetry data and using a machine learning model;
infer a power-saving transition for the candidate AP based on the telemetry data using the machine learning model; and
operate the candidate AP in a power-saving mode as per the power-saving transition.

17. The system of claim 16, wherein the network management system is further configured to:
train the machine learning model, during a learning phase, to learn one or more reduced utilization patterns for the plurality of APs, based on the network activity reported in the telemetry data; and
identify the candidate AP and infer the power-saving transition for the candidate AP based on the learned one or more reduced utilization patterns.

18. The system of claim 16, wherein the network management system is further configured to:
infer a power-on transition for the candidate AP based on roaming characteristics of a client device and using the machine learning model; and
resume operations of the candidate AP as per the power-on transition in advance of the client device associating with the candidate AP.

19. The system of claim 18, wherein the network management system is further configured to:
determine a set of neighbor APs of a given AP of the plurality of APs;
steer one or more client devices associated with the given AP to one of the set of neighbor APs responsive to determining that a count of the one or more client devices associated with the given AP has reduced below a threshold number; and
operate the given AP in the power-saving mode after the one or more client devices have been steered to the one of the set of neighbor APs.

20. The system of claim 16, wherein the network management system is further configured to:
operate the candidate AP in a sleep mode;
operate the candidate AP in a deep-sleep mode; or
first operate the candidate AP in the sleep mode and then operate the candidate AP in the deep-sleep mode responsive to determining no-data traffic for the candidate AP for a predefined duration after the candidate AP entered the sleep mode.
